(19) United States
(12) Patent Application Publication
(10) Pub. No.: US 2008/0185225 A1
(43) Pub. Date: Aug. 7, 2008

(54) Step ladder stabilizers

(76) Inventor: Robert G. Spengler, North Billerica, MA (US)

Correspondence Address: PEARSON & PEARSON, LLP, 10 GEORGE STREET, LOWELL, MA, 01852, US

(21) Appl. No.: 12/080,636

(22) Filed: Apr. 4, 2008

Related U.S. Application Data
(63) Continuation-in-part of application No. 11/799,988, filed on May 3, 2007.
Application No. 11/799,988 is a division of application No. 10/345,068, filed on Jan. 15, 2003, now Pat. No. 7,216,742.

(51) Int. Cl. E06C 1/383; E06C 7/10

(52) U.S. Cl. 182/172; 292/36

(57) ABSTRACT

A step ladder stabilizer for mounting behind the front step portion of a step ladder and having two adjusting legs which adjust as a slide moves vertically along a channel having a bracket at each end of the channel for attaching to the rear of the ladder steps. Within each of the steps is an adjustable extension leg used for various stability requirements. When not in use, the ladder stabilizer may be closed flush against the back of the ladder steps or it is easily removed from the step ladder.

This application is a Continuation-in-Part of application Ser. No. 11/799,988, filed May 3, 2007, which is a Divisional of application Ser. No. 10/345,068, filed Jan. 15, 2003 (now U.S. Pat. No. 7,216,742 B2), both of which are hereby incorporated herein by reference.

### BACKGROUND OF THE INVENTION

1. Field of the Invention

The present invention relates generally to ladders and in particular to a step ladder stabilizer which is attached to a step ladder and provides safety by reducing the possibility of slipping or tipping.

2. Description of Related Art

Ladders are known to be unstable and often require the assistance of a second person for steadying the ladder when a first person has climbed the ladder. However, another person is not always available when a ladder has to be used. There have been many devices made for stabilizing a ladder, and yet they do not solve the problems of being adjustable to all site conditions, convenient to use, easily installed on the ladder, compromising the integrity of the ladder, interfering with the use of the ladder, retractable and out of the way for storage, and providing stabilization when one side of the ladder is close to a wall.

U.S. Pat. No. 3,891,054 issued to Clayton E. Larson in 1975 discloses a step ladder stabilized by channel members which are fixed on each side of the lowest rung of the ladder and have an extendable member. Braces are provided at the upper rungs to provide rigidity and resistance against sway. However, it is not adjustable to all site conditions and adds very little stabilization to the ladder.

U.S. Pat. No. 4,964,488 issued to John V. Stewart on Oct. 23, 1990 discloses a step ladder stabilizer for a step ladder comprising a brace hinged to a ladder rail and an arm hinged to the rail at a lower position trussing the brace. The stabilizers on each side of the ladder fold against the front of the ladder. However, this ladder stabilizer is not adjustable to all site conditions and it interferes with the use of the ladder when not in use.

U.S. Pat. No. 5,868,222, issued to Francois Charbonneau on Feb. 9, 1999 discloses an extension ladder having a telescopic tube mounted to each side of the ladder's lower section and a lateral brace to support the telescopic tube extending away from each side of the ladder. However, the telescopic tubes bolt to the ladder which may compromise the integrity of the ladder, it is not easily installed on the ladder, and it is cumbersome and inconvenient to use. Also, it has removable pins and clips which are easily lost.

U.S. Pat. No. 4,147,231, issued to Douglas A. Chantler et al. on Apr. 3, 1979 discloses a ladder stabilizing device connected on the outer sides of the side pieces of the ladder. The device comprises outwardly extensible legs having an upper leg part connected to a slide plate on the side of the ladder which adjusts up and down. A lower leg support extends from the side of the ladder near the bottom and extends out to the upper leg part at its lower end. The upper and lower leg parts lie flat against the side of the ladder for storage when the ladder is not in use. However, this device lifts the ladder legs off the surface which eliminates the stability which otherwise would be provided by these legs. Also, this device is cumbersome and inconvenient to use.

U.S. Pat. No. 4,519,477, issued to Robert Ralston on May 28, 1984 discloses an adjustable stabilizer device for an extension ladder with hollow rungs comprising two stabilizing elements, an upper bracket and a lower bracket. Each stabilizing element connects to an upper right angle bracket which connects to a side wall bracket. The stabilizing elements are connected to each other by rods which extend through the hollow rungs of the ladder and attach to the side wall brackets. When the ladder is not in use the stabilizer elements are retained flush against the sides of the ladder for storage. However, this device is not adjustable to all site condition, is cumbersome and inconvenient to use, and has removable pins and clips which can be easily lost.

### SUMMARY OF THE INVENTION

Accordingly, it is therefore an object of this invention to provide a step ladder stabilizer which attaches to the rear of the front step portions of the ladder and is adjustable vertically whereby the stabilizer legs adjust horizontally toward or away from the front step section of the ladder.

It is another object of the invention to provide a step ladder stabilizer which closes flush against the step ladder when not in use.

It is a further object of this invention to provide a method of stabilizing a step ladder by attaching a stabilizer to the rear of the front step portion of the ladder and adjusting legs of the stabilizer a distance from the front step portion and away from each other.

These and other objects are accomplished by a stabilizer for a step ladder comprising means for attaching an upper portion of the stabilizer to the step ladder, means attached to the upper portion of the stabilizer for mounting a pair of legs, and means attached to the legs for securing the legs to a lower portion of the ladder, the distance between the legs being controlled by a spreader bar. The attaching means of an upper portion of the stabilizer to the step ladder comprises a channel, the channel comprises an upper bracket and a lower bracket for attaching the channel to steps of the step ladder. The leg mounting means comprises a slide lock attached to the channel, and means extending from a portion of the slide lock for attaching the legs to the slide lock. The legs securing means to a lower portion of the ladder comprises arms extending from each of the legs, the arms being connected to clamps for attaching to a step of the ladder. Each of the legs comprises an adjustable extension leg within each of the legs. The adjustable extension leg within each of the legs is controlled by a lock lever mechanism positioned on each of the legs.

The objects are further accomplished by a stabilizer for a step ladder comprising a channel, the channel comprises a gear track along one side, means positioned on an upper portion and a lower portion of the channel for attaching the channel to a front step portion of the step ladder, means attached to the channel for mounting a pair of legs wherein the legs extend or retract in accordance with the movement of the mounting means along the channel, means attached between the pair of legs for fixing the legs in a spaced-apart position and for releasing the legs to enable the pair of legs to be moved adjacent to the channel, and means for securing each leg of the pair of legs to the front step portion of the step ladder. The mounting means comprises a slide lock adapted to move along the channel and having a lock lever to control the slide lock. The pair of legs securing means comprises a first arm attached between a first one of the pair of legs and the front step portion of the step ladder, and a second arm attached between a second one of the pair of legs and the front step portion of the step ladder.

The objects are further accomplished by a stabilizer for a step ladder comprising a channel having an upper bracket and a lower bracket for mounting the channel to a front step portion of the step ladder, a slide lock adapted to slide along the channel and be locked at a preferred position, a leg connector rotatably attached at an end of the slide lock, a first leg of the stabilizer attached to a first side of the leg connector, the first leg extending downward away from the channel, a second leg of the stabilizer attached to a second side of the leg connector, the second leg extending downward away from the channel, a spreader bar attached between the first leg and the second leg, a first arm of the stabilizer having a first end attached to the first leg and a second end adapted to attach to the front step portion of the step ladder, and a second arm having a first end attached to the second leg and a second end adapted to attach to the front step portion of the step ladder. The spreader bar comprises means for folding-up the spreader bar. The slide lock comprises means for securing the slide lock along a gear track on the channel at the preferred position to stabilize the step ladder. The slide lock securing means comprises a control lever having teeth for meshing with the gear track on the channel. Each of the first leg and the second leg comprises an extension leg which extends from the first leg and the second leg to stabilize the step ladder. Each of the first leg and the second leg comprises a leg lock assembly, the leg lock assembly comprises a lock lever for securing the extension leg in a preferred position to stabilize the step ladder. The stabilizer closes up against the channel when the slide lock is moved to a top portion of the channel.

The objects are further accomplished by the combination of a step ladder having a front step section and a rear prop section, the rear prop section being movably attached to a top portion of the step ladder adjacent to the front step section, a step ladder stabilizer, attached to the front step section and extending between the front step section and the rear prop section to provide stabilization, comprising a channel having an upper bracket and a lower bracket for mounting to the front step section of the step ladder, a slide lock adapted to slide along the channel and be locked at a preferred position, a first leg attached to a rotatable portion of the slide lock, the first leg extending downward away from the channel, a second leg attached to the rotatable portion of the slide lock, the second leg extending downward away from the channel, a spreader bar attached between the first leg and the second leg, a first arm having a first end attached to the first leg and a second end adapted to attach to the front section of the step ladder, and a second arm having a first end attached to the second leg and a second end adapted to attach to the front step section of the step ladder. The spreader bar comprises means for folding up the spreader bar. The slide lock comprises means for securing the slide lock along the channel at the preferred position to stabilize the step ladder. The step ladder stabilizer closes up against the front step portion of the step ladder when the slide lock bracket is raised along the channel.

The objects are further accomplished by a stabilizer for a step ladder comprising a channel having an upper bracket and a lower bracket for mounting the channel to a front step portion of the step ladder, a slide lock bracket adapted to slide along the channel and be locked at a preferred position, a first leg of the stabilizer attached to a first side of the sliding lock bracket, the first leg extending downward away from the channel, a second leg of the stabilizer attached to a second side of the sliding lock bracket, the second leg extending downward away from the channel, a spreader bar attached between the first leg and the second leg, a first arm of the stabilizer having a first end attached to the first leg and a second end adapted to attach to the front step portion of the step ladder, and a second arm having a first end attached to the second leg and a second end adapted to attach to the front step portion of the step ladder. The spreader bar comprises means for folding-up the spreader bar. The slide lock bracket comprises means for securing the slide lock bracket along the channel at the preferred position to stabilize the step ladder. Each of the first leg and the second leg comprises an extension leg which extends from the first leg and the second leg to stabilize the step ladder. The stabilizer closes-up against the channel when the slide lock bracket is raised along the channel.

The objects are further accomplished by a slide lock assembly comprising a lever having means on an end of a right angled portion of the lever for griping a gear track surface of a channel when the lever is in a nonactivated position, a frame for mounting the slide lock assembly to grooved surface of the channel, the frame having an opening for the end of the right angled portion of the lever to enter, means for securing the right angled lever within a pair of walls running on the outside and length of the frame to enable the lever to rotate about the securing means wherein the right angled portion of the lever protrudes through the opening in the frame when the lever is in the nonactivated position, and a U-shaped spring, one end attached to the frame below a handle portion of the lever and the other end positioned against an underside of the handle portion of the lever wherein the U-shaped spring maintains the lever in the nonactivated position. The griping means comprises a plurality of teeth on the end of a right angled portion of the lever for meshing with the gear track of a channel. The U-shaped spring comprises a U-shaped leaf spring, and a leg connector is rotatably attached to a lower end of the slide lock assembly.

Additional objects, features and advantages of the invention will become apparent to those skilled in the art upon consideration of the following detailed description of the preferred embodiments exemplifying the best mode of carrying out the invention as presently perceived.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a perspective view of a step ladder having a step ladder stabilizer attached thereto;

FIG. 2 is a perspective view of the step ladder stabilizer in the open position;

FIG. 3 is a top view of a channel with sliding bracket and stabilizer legs attached to each side of the sliding bracket;

FIG. 4 is a front elevational view of a hinged connecting plate;

FIG. 5 is a side elevational view of a ball joint;

FIG. 6 is a side elevational view of a ladder step clamp;

FIG. 7 is a plan view of a leg side clip;

FIG. 8 is a top view of a leg of the step ladder stabilizer showing side slots for receiving bolt heads;

FIG. 9 is a side elevational view of a portion of the leg of the step ladder stabilizer having a lock lever;

FIG. 10 is a perspective view of the step ladder stabilizer of FIG. 2 in the closed position;

FIG. 11 is a front elevational view of an alternate embodiment of a ladder stabilizer for an extension ladder;

FIG. 12 is a front elevational view of the alternate embodiment of FIG. 11 showing an extension ladder with a stabilizer open on one side and closed on the other side of the extension ladder;

FIG. 13 is a top view of a slide lock of the extension ladder stabilizer; and

FIG. 14 is a side elevational view of an expansion insert for mounting a protective guard on sides of the extension ladder.

FIG. 15 is a perspective view of a step ladder having an alternate embodiment of a step ladder stabilizer attached thereto;

FIG. 16 is a perspective view of the alternate embodiment of the step ladder stabilizer of FIG. 15 in the open position.

FIG. 17 is a side elevational cross-sectional view of a gear track slider positioned on a gear track of the alternate embodiment having a swivel leg connector attached at one end.

FIG. 18 is a front elevational view of a swivel leg connector attached to an end of the gear track slide and two legs extending from the swivel leg connector.

FIG. 19 is an end view of the gear track slide with a locking lever removed.

FIG. 20 is a side elevational cross-sectional view of a leg lock assembly positioned on a leg of the alternate embodiment.

FIG. 21 is an end view of a leg lock assembly showing the side walls for receiving the lock lever.

FIG. 22 is a perspective view of a U-clip.

FIG. 23 is a top view of an upper step clamp attached to the gear track slide positioned on an upper end of a channel.

FIG. 24 is a perspective view of the step ladder stabilizer of FIG. 16 in a closed position when not in use.

### DESCRIPTION OF ILLUSTRATIVE EMBODIMENTS

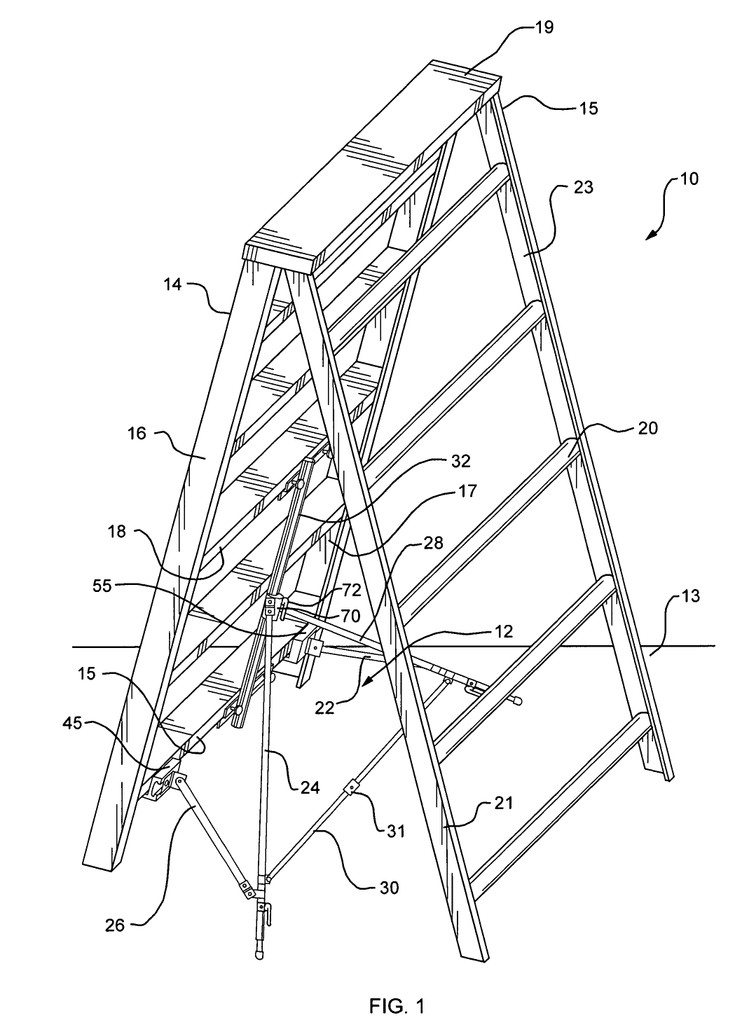

Referring to FIG. 1, a perspective view of a step ladder 10 is shown comprising a ladder stabilizer 12 attached thereto. The step ladder 10 comprises a front step section 14 and a rear prop section 15. The front step section 14 comprises side rails 16, 17 and a plurality of steps 18 between the side rails 16, 17. The rear prop section 15 supports the front step section 14 and has secondary side rails 21, 23 with a plurality of bars 20 between such rails 21, 23 for strength and inherent stability of the step ladder 10. The bars 20 are generally not of sufficient strength for climbing. With the ladder stabilizer 12 attached to the step ladder 10, the ladder stabilizer 12 may be closed-up to rest adjacent to the front step section 14 and the rear prop section 15 closed against the stabilizer 12 and the front step section 14.

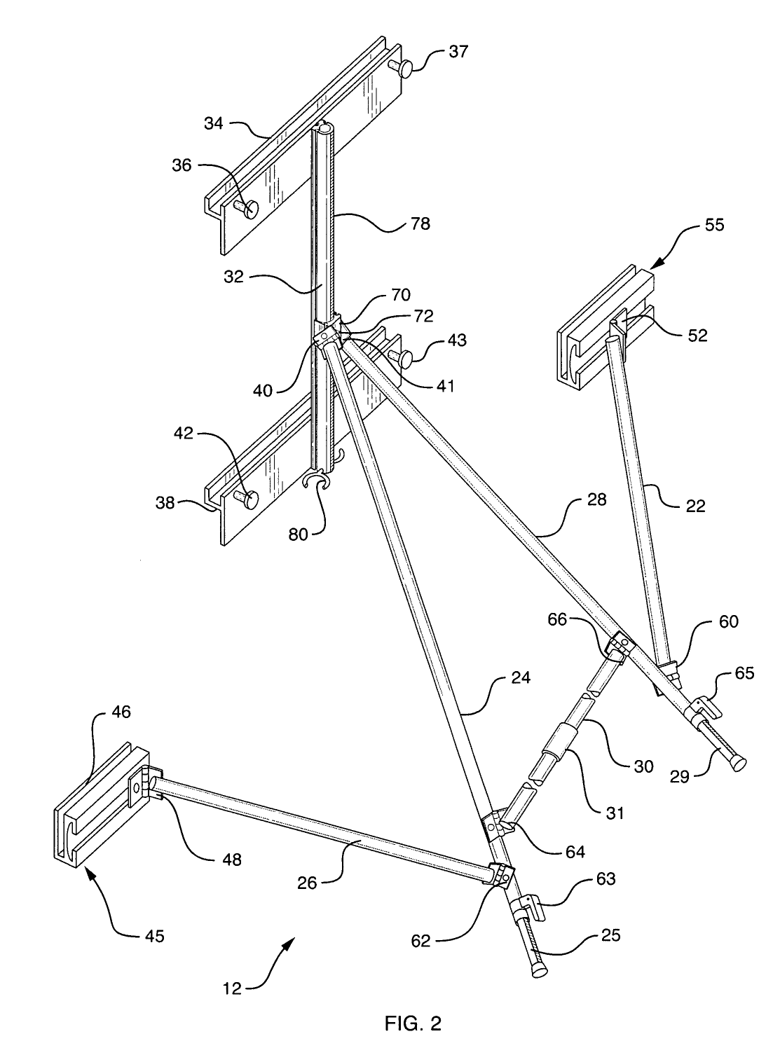

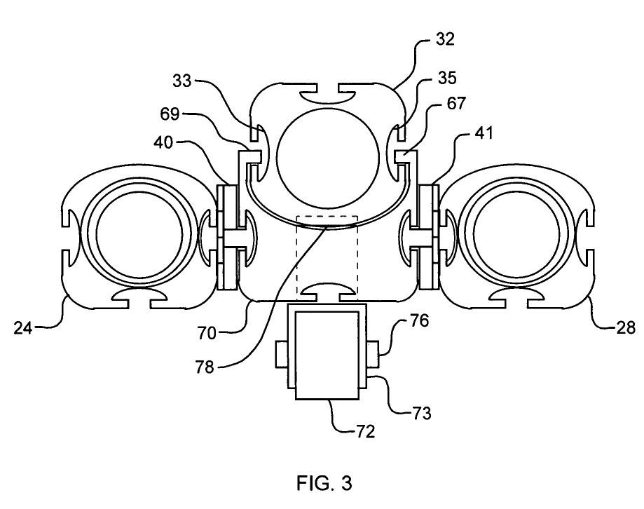

Referring to FIG. 1 and FIG. 2, FIG. 2 is a perspective view of the ladder stabilizer 12 according to the present invention for mounting on step ladder 10. The ladder stabilizer 12 comprises a channel 32 having an upper bracket 34 and a lower bracket 38 for attaching the stabilizer 12 to a back portion of steps 15, 18 of the front step section 14. Screws 36, 37 are provided in upper bracket 34 for securing the upper bracket 34 to an upper step 18, and screws 42, 43 are provided in lower bracket 38 for securing the lower bracket 38 to a lower step 15. Other securing means such as bolts are equally applicable in place of the screws 36, 37, 42 and 43. A sliding bracket 70 is positioned on channel 32 to slide up and down channel 32, and it is secured at a desirable position along the channel 32 by a slide lock 72 (FIG. 3). A first stabilizer leg 24 attaches via a hinged connecting plate 40 to the sliding bracket 70, and a second stabilizer leg 28 attaches to the other side of the sliding bracket 70 via hinged connecting bracket 41. The stabilizer legs 24, 28 extend downward toward a support surface 13 away from the front step section 14 of the step ladder 10 to provide stabilization for the step ladder 10. A spreader bar 30 connects between stabilizer leg 24 and stabilizer leg 28. Midway along spreader bar 30 is a release bracket 31 to allow the spreader bar 30 to fold up when slide lock 72 is raised along channel 32 in order to close-up the step ladder stabilizer 12.

Still referring to FIG. 2, a first arm 26 extends from the stabilizer leg 24, below a first end 64 of the spreader bar 30, to a clamp 45. The first arm 26 connects to the stabilizer leg 24 by means of a hinged connecting plate 62 and the other end of the arm 26 comprises a hinged connecting plate 48 which attaches to the clamp 45. Clamp 45 attaches the arm 26 to a step such as step 15 of ladder 10. A second arm 22 extends from the stabilizer leg 28, just below the second end 66 of the spreader bar 30, to a clamp 55. The second arm 22 connects to the stabilizer leg 28 by means of a hinged connecting plate 60 and the other end of the arm 22 comprises a hinged connecting plate 52 connected thereto which attaches to the clamp 55. Each of the hinged connecting plates 60, 62 is fixed at one end with a bolt and nut and the other end comprises a bolt with a nylon or plastic washer and a cap nut to enable one section of the hinge to rotate around the bolt.

Referring to FIG. 3, a top view of a channel 32 with the sliding bracket 70 is shown having hinged connecting plates 40, 41 at the ends of the stabilizer legs 24, 28 respectively connected to sliding bracket 70. The sliding bracket 70 comprises right angle arms 69, 67 which protrude into slots 33, of channel 32 respectively and keep the bracket 70 secured to channel 32 as it slides along channel 32 while being adjusted. A lever 72 rotates about a pin 76 and when closed as shown in FIG. 3, secures the sliding bracket 70 to a position along channel 32.

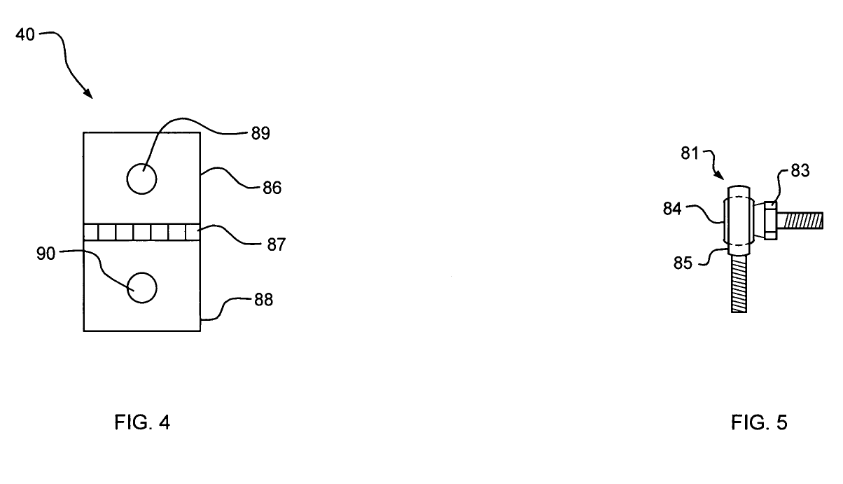

Referring to FIG. 4, a front elevational view of the hinged connecting plate 40 is shown comprising a first section 86 having a center hole 89 and a second section 88 comprising a center hole 90. The first section 86 and the second section 88 are connected together by a hinge 87. The hinge connecting plate 40 and similar hinge connecting plates 41, 48, 52, 60, 62, 64 and 66 are used in the ladder stabilizer 12 at connection points to facilitate movement in three directions when the opening and closing the ladder stabilizer 12 attached to the step ladder 10. Typically, one section 86 of the hinged connecting plate 40 is connected firmly with a bolt and a nut through hole 89, and the other section 88 has a bolt extending through hole 90 with a nylon or plastic washer and a cap nut to enable that section of the hinged connecting plate 40 to rotate around the bolt.

Referring now to FIG. 5, a side elevational view of a ball joint 81 is shown. The ball joint may be used as an alternate embodiment for the hinged connecting plates 40, 41, 48, 52, 60, 62, 64, 66. A rotating portion 85 of the ball joint 81 comprises a threaded bolt 83 extending from a side and the rotating portion 85 rotates about the ball 84.

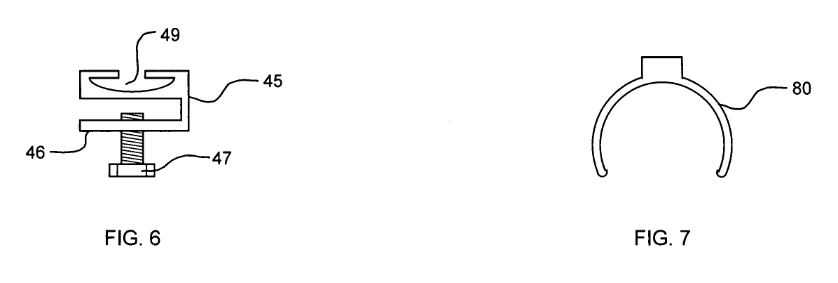

Referring now to FIG. 2 and FIG. 6, FIG. 6 shows a side elevational view of the ladder step clamp 45, 55. It comprises a slot 49 for receiving the head of a bolt which is used to secure, for example, the hinged connecting plate 40 to the clamp 45. A U-shaped opening 46 is provided for inserting a bottom edge of the ladder steps 15, 18 when the ladder step clamp 45, 55 is secured to the ladder steps 15, 18 by a bolt 47.

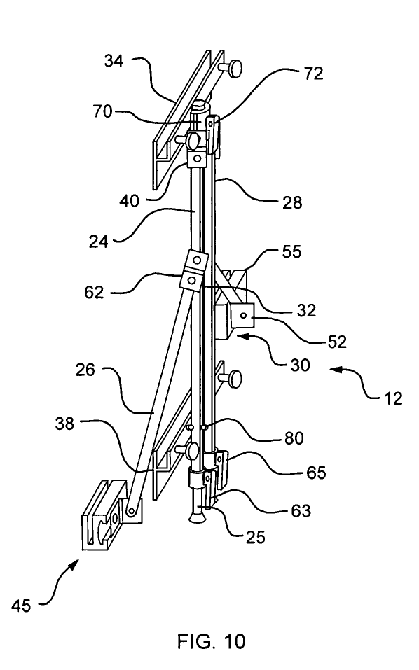

Referring to FIG. 2 and FIG. 7, FIG. 7 is a plan view of a clip 80 for retaining the stabilizer legs 24, 28 adjacent to channel 32 when the ladder stabilizer is in the closed position as shown in FIG. 10. Clips 80 are secured to opposite sides of channel 32 as shown in FIG. 2.

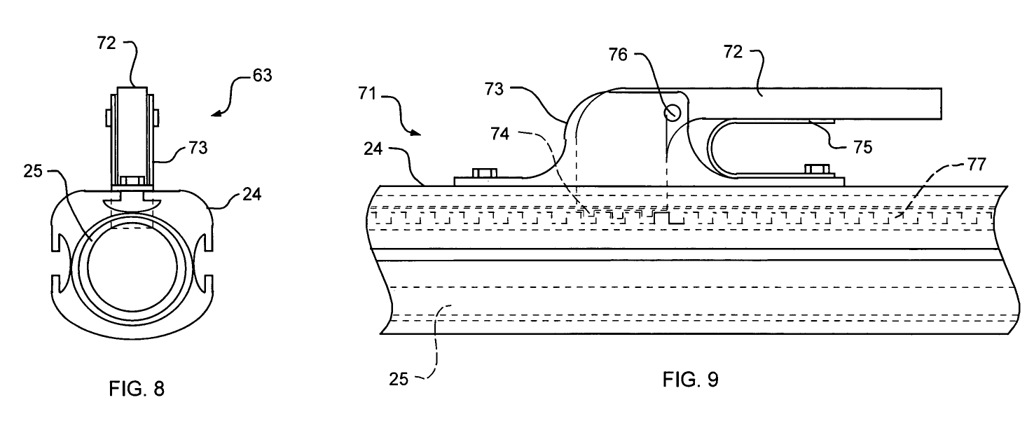

Referring now to FIG. 8, a top view is shown of the leg 24 of the step ladder stabilizer 12 including an inner extension leg 25 and a lock lever assembly 71 mounted on the outside of the stabilizer leg 24 for securing the extension leg 25 at a particular position along the stabilizer leg 24. The stabilizer leg 28 is similarly constructed.

Referring to FIG. 8 and FIG. 9, FIG. 9 is a side elevational view of a portion of the leg 24 of the step ladder stabilizer comprising the lever lock assembly 71. The lever lock assembly 71 comprises an outer frame 73 having a right-angled lever 72 positioned within the side walls of the frame 73 and rotating about a cylindrical pin 76. A U-shaped leaf spring 75 has a first portion attached to a base of the frame under the lever 72 and a second portion resting against the under side of the lever 72. The end of the right-angled lever 72 comprises rectangular teeth 74 as shown in FIG. 9 having a height of approximately one-eighth inch which meshes with gear track rectangular teeth 77 having a height of approximately one-eighth inch and located along a portion of the side of the inner extension leg 25. The leaf spring 75 keeps the right-angled lever teeth 74 meshed with the teeth 77 so that the lever lock assembly 71 is self-locking, and only unlocks when the lever 72 is pushed inward toward the gear track teeth 77. An opening is provided in the side of the stabilizer leg 24 for the right-angled lever 72 to enter. The ends of the lever lock frame 73 are secured to the side of the stabilizer leg 24 by bolts and nuts or rivets.

Referring to FIG. 10, a perspective view of the step ladder stabilizer 12 of FIG. 2 removed from the step ladder 10 is shown in the closed position. In order to achieve the closed position removed from the step ladder 10, the upper bracket 34 and the lower bracket 38 are removed from steps 18 and 15 respectively, the clamp 45 at the end of the first arm 26 is removed from step 15, and the clamp 55 at the end of the second arm 22 is also removed from step 15. Then the release bracket 31 of the spreader bar 30 is actuated and the spreader bar 30 folds-up which causes the stabilizer legs 24, 28 to move toward each other. Next, the lever 72 of the slide lock 70 is loosened, and the slide lock 70 is moved toward the top of the channel 32 causing the two stabilizer legs 24, 28 to close parallel to the vertical channel 32 and snap into clips 80. The arms 22, 26 rest along the sides of stabilizer legs 24, 28.

The preferred embodiment of the step ladder stabilizer shown in FIG. 2 comprises elements embodied with aluminum having the following dimensions, but one of ordinary skill in the art will recognize that there are many variations to such dimensions that will work equally well. In one embodiment, the channel 32 is 1½ inches wide×½ inch deep×30 inches long with a slot opening of ¾ inch wide. The stabilizer legs 24, 28 are 55 inches long extendable to 70 inches and are 1 inch in diameter. The spreader bar 30 is 38 inches long. The arms 22, 26 are 1 inch in diameter and 20 inches long.

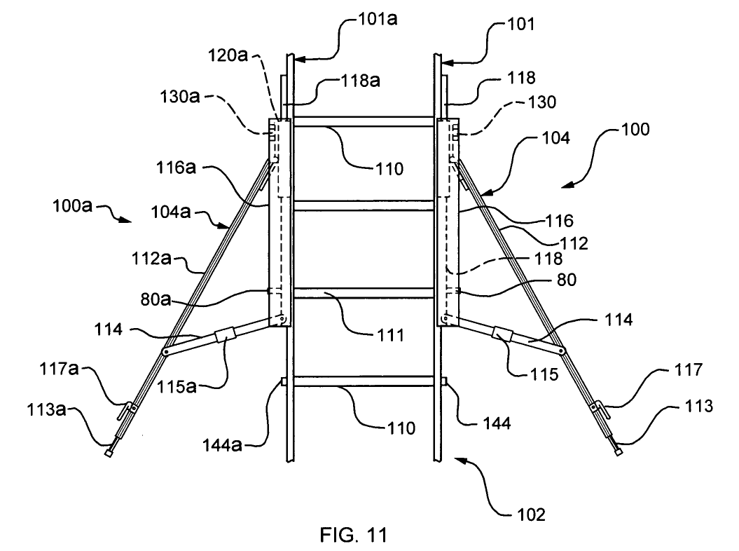

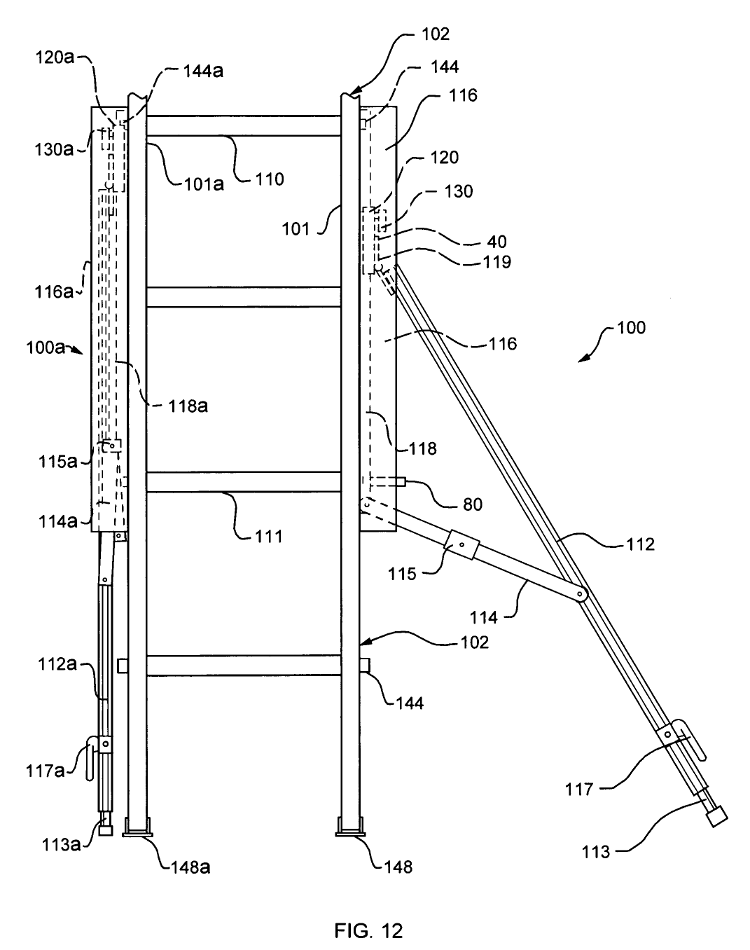

Referring now to FIG. 11, a front elevational view is shown of an alternate embodiment of a ladder stabilizer 100 for use with an extension ladder 102. The extension ladder stabilizers 100, 100a attach to each side rail 101, 101a of a lower section of the ladder 102 (an upper section is not shown). FIG. 12 is a front elevational view of the extension ladder 102 of FIG. 11 showing the ladder stabilizer 100 in an opened position on a first or right side of the ladder 102 and a second ladder stabilizer 100a in a closed position on a second or left side of the ladder 102.

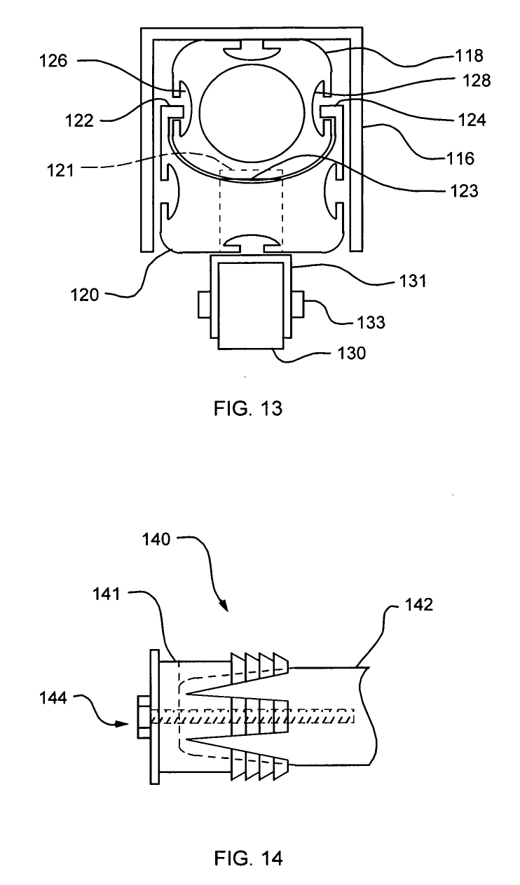

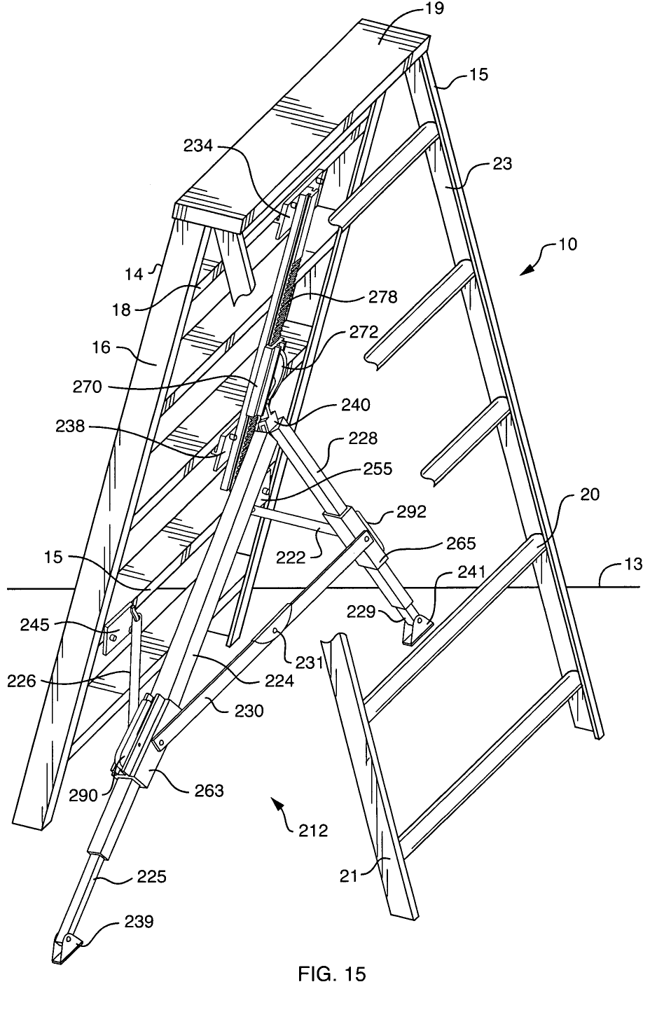

Referring to FIG. 12, the extension ladder stabilizer 100 comprises a U-shaped guard 116 in which a channel 118, having a gear track 123 along its outer side length, which is the same as gear track 78 on channel 32 as shown in FIG. 2, is positioned and attached to the side rail 101 of the ladder 102 at an upper end of the U-shaped guard 116 by means of a first expansion insert 144 (FIG. 14) that is inserted into channel 118, into the side rail 101 of the ladder 102, into the step 110 and tightened in place. A second expansion insert 144a is inserted into channel 118a and U-shaped guard 116a, into the side rail 101a of the ladder 102, into step 111 and tightened in place. A slide lock bracket 120 (FIG. 13) is positioned on channel 118 for securing or locking the open and closed position of the ladder stabilizer 100. The slide lock bracket 120 is a self-locking bracket having a level lock assembly 131 with an inwardly movable lever 130. A right angle portion of lever 130 protrudes into the gear track 123 along the outer side of the channel 118 and secures the slide lock bracket 120 to the channel 118. The lever 130 is the same as lever 72 in FIG. 10 which engages with gear track 78 in FIG. 2. A hinged connecting plate 40 as shown in FIG. 4 is attached to a lower portion of the slide lock bracket 120 below the lever 130. A first section 86 of the hinged connecting plate 40 is attached to the slide lock bracket 120 by a bolt 119 or other commonly known connecting means. A second section 88 is attached by another bolt or equivalent to an extending leg 112. The extending leg 112 is able to rotate about bolt 119 for positioning purposes and extends toward the surface on which the extension ladder 102 is placed at a distance away from the side of the ladder 102 thereby providing stabilization to the ladder 102. An arm 114 is attached between the extending leg 112 and the lower end of the channel 118 which limits the distance the extending leg 112 is moved away from the side of the ladder 102. A release clip 115 is positioned in the arm 114 to permit the arm 114 to fold-up when the ladder stabilizer 100 is closed-up as shown on the opposite side of ladder 102. As the slide lock bracket 120 moves up and down the channel 118, the extending leg 112 moves toward the ladder 102 and away from the ladder 102 to a preferred position. A lower extension section 113 of the extending leg 112 is adjustable.

Referring again to FIG. 11 and FIG. 12, the extension ladder stabilizer 100a on the left side of ladder 102 has the same components as the ladder stabilizer 100 on the right side of ladder 102. The letter “a” is added to the reference number to indicate similar stabilizer elements on the left side of the ladder 102 as are on the right side of ladder 102. Ladder stabilizer 100a is put into the closed position by raising the slide lock 120a along the channel 118a and adjusting release clip 115a so that the arm 114a folds-up allowing the extending leg 112a to move toward the side rail 101a of the ladder 102. If the lower extension section 113a was extended, then it has to be retracted to permit the ladder stabilizer 100a to close against the left side of the ladder 102 and to be within the U-shaped guard 116. The levers 117, 117a control the length of the lower extension sections 113, 113a respectively.

Referring to FIG. 13, a top view of channel 118 attached within U-shaped guard 116 is shown with slide lock bracket 120 having right angle arms 122, 124 which protrude into slots 126, 128 respectively of the channel 118. The right angle arms 122, 124 keep the slide lock bracket 120 secured to channel 118 as it slides along channel 118. The lever 130 rotates about a pin 133, and when lever 130 is normally closed as shown in FIG. 13, it secures the slide lock bracket 120 along channel 118. The right angle portion of the lever 130 protrudes into the slide lock bracket 120 and presses against or meshes with the outer side of the channel 118 having the gear track 123. The channel 118 is provided with multiple slots such as slots 121, 126, 128 for receiving the lever 130, a bolt head, or right angle arms 122, 124 depending on the use of the channel 118 component. The slide lock bracket 120 is provided with an opening for receiving the right angle portion of the lever 130 that presses against or meshes with the gear track 123 of the channel 118.

Referring to FIG. 14, a side elevational view of the expansion insert 144, 144a is shown for mounting the U-shaped guard 116 on the side of the ladder 102. The expansion insert comprises a bolt 144 inserted within two mating sections 141, 142 for pulling the sections 141, 142 together, when the bolt 144 is tightened thereby expanding section 141.

The preferred embodiment of the extension ladder stabilizers 100, 100a shown in FIG. 11 comprise elements with the following dimensions, but one of ordinary skill in the art will recognize that there are many variations to such dimensions that will work equally well. Each channel 118, 118a is 1½ inches wide by ½ inches deep by 30 inches long with a slot opening of ¾ inches wide. The extending legs 112, 112a are 1 inch in diameter and 55 inches long with the extending sections 113, 113a that extend another 15 inches. The spreader arm 114, 114a is 1 inch by ⅛ inch aluminum flat bar (FB) and 15 inches long.

### Alternate Step Ladder Stabilizer Embodiment

Referring to FIG. 15, a perspective view of the step ladder 10 is shown comprising an alternate embodiment of a step ladder stabilizer 212. As previously described for FIG. 1, the step ladder comprises a front step section 14 and a rear prop section 15. A portion of the rear prop section 15 is removed in FIG. 15 to provide a clear view of the step ladder stabilizer 212 attached to the front step section 14. The front step section 14 comprises side rails 16, 17, and a plurality of steps 18 between the side rails 16, 17. The rear prop section 15 supports the front step section 14 and has secondary side rails 21, 23 with a plurality of bars 20 between such rails 21, 23 for strength and inherent stability of the step ladder 10. The bars 20 are generally not of sufficient strength for climbing. The alternate embodiment ladder stabilizer 212 attaches to the step ladder 10, and the stabilizer 212 may be closed to rest adjacent to the front step section 14, and the rear prop section 15 closes against the stabilizer 212.

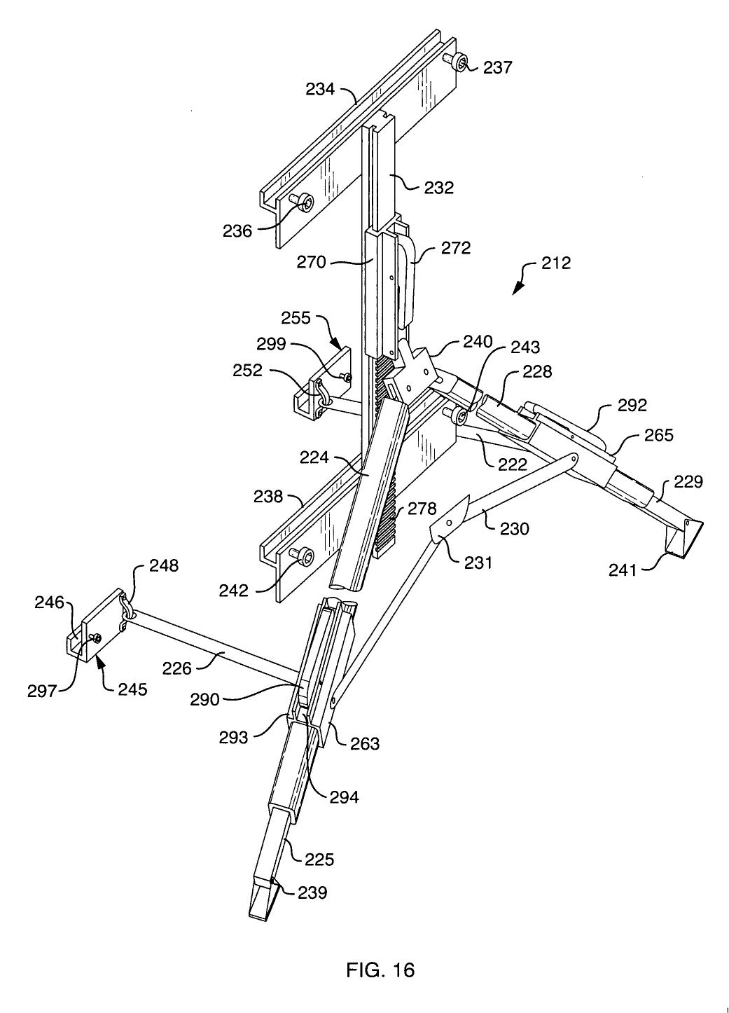

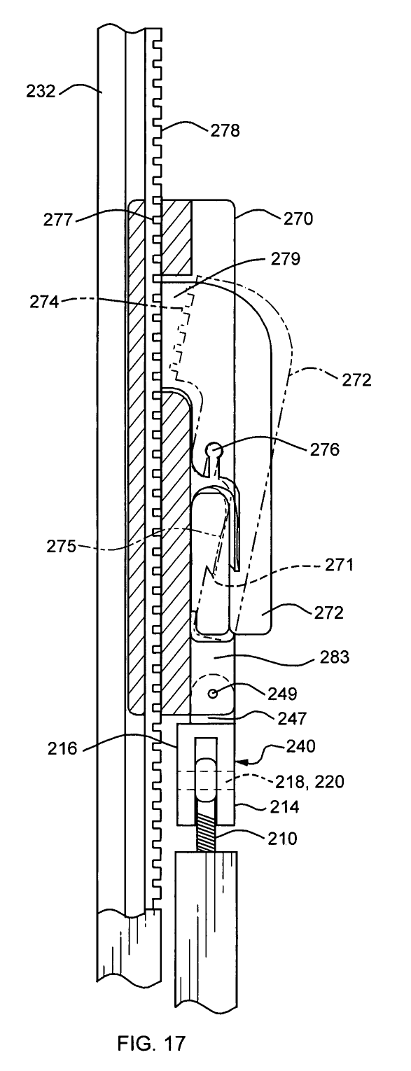

Referring to FIG. 15, FIG. 16, FIG. 17 and FIG. 23, FIG. 16 is a perspective view of the step ladder stabilizer 212 according to the design of the alternate embodiment which mounts on the step ladder 10. FIG. 17 is a side elevational cross-section view of a gear track slide lock 270 positioned on a gear track 278 of the alternate embodiment having a swivel leg connector 246 attached at a lower end. The ladder stabilizer 212 comprises a channel 232 having an upper bracket 234 and a lower bracket 238 for attaching the stabilizer 212 to the back portion of steps 15, 18 of the front step section 14.

FIG. 23 shows a top view of the upper bracket 234 attached to the channel 232 and positioned on an upper end of the channel 232. Screws 236, 237 are provided in the upper bracket 234 for securing the upper bracket 234 to a lower edge of the upper step 18, and screws 242, 243 are provided in a lower step bracket 238 for securing the lower bracket 238 to a lower edge of the lower step 15. Other securing means such as threaded bolts are equally applicable in place of screws 236, 237, 242 and 243. The gear track slide lock 270 is positioned on channel 232, and it is secured at a desirable location along the channel 232 by a locking lever 272 (FIG. 17). The stabilizer legs 224, 228 extend downward toward a support surface 13 away from the front step section 14 of the step ladder 10 to provide stabilization for the step ladder 10. Inside of the stabilizer legs are extensions legs 225, 229 which are controlled by the leg lock assemblies 263, 265. At the end of each of the extension legs 225, 229 is a triangular leveler 239, 241 that easily rotates about a mounting bolt for ground level adjustment. A spreader bar 230 connects between a side of a first leg lock assembly 294 located on leg 225 and a side of a second leg lock assembly 292 located on leg 294. Midway along spreader bar 230 is a release bracket 231 which allows the spreader bar 230 to fold up when the slide lock 270 is raised along channel 232 in order to close the step ladder stabilizer 212 which attaches to the ladder 10.

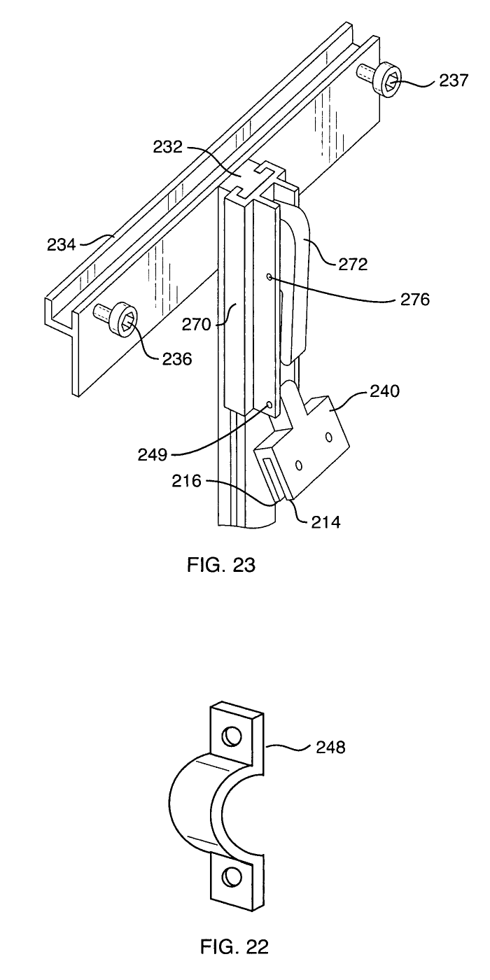

Referring to FIG. 16 and FIG. 22, FIG. 22 is a perspective view of a U-clip 248 having holes at each end for receiving screws or rivets. A first arm 226 extends from a side of the leg lock 263 located on the leg 224 to a clamp 245 comprising U-clip 248. The U-clip 248 fits through a hole in the end of the first arm 226 and both ends of the U-clip 248 are secured by rivets or screws to a side of the clamp 245. The clamp 245 comprises a shorter front wall than a back wall as shown in FIG. 16 and a space 246 between these walls for receiving an edge of step 15. Clamp 245 attaches to a step such as step 15 of ladder 10 and is secured by an alum head set screw 297. A second arm 222 extends from a side of the leg lock assembly 265 located on the leg 228 to a clamp 255 comprising a U-clip 252. The clamp 255 is similar to clamp 245 except for a U-clip 252 being mounted on a back left side of clamp 255 instead of the right side. The U-clip 252 fits through a hole in the end of the second arm 222 and both ends of the U-clip 252 are secured by rivets or screws to a side of the clamp 255. Clamp 255 attaches to a step, such as step 15 of ladder 10, and is secured by an alum head set screw 299.

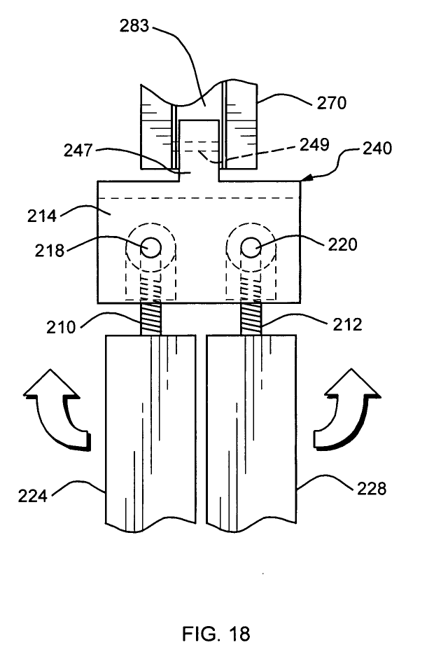

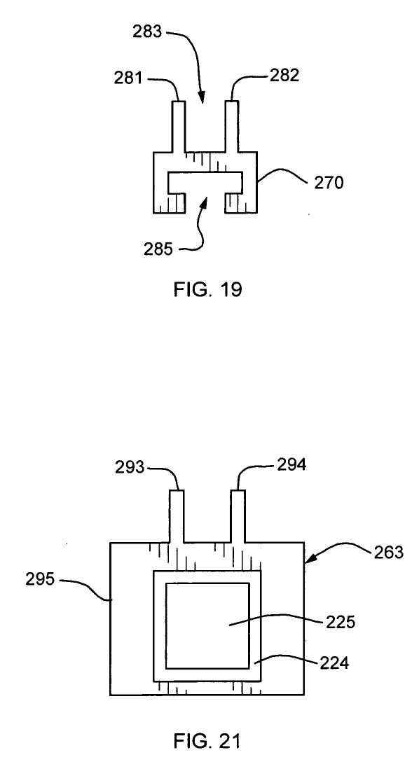

Referring to FIG. 17, FIG. 18, and FIG. 19, FIG. 18 is a front elevational view of a swivel leg connector 240 attached to a lower end of the gear track slide lock 270, and two legs 224, 228 extend from the swivel leg connector 240. FIG. 19 is an end view of the gear track slide lock 270 with a locking lever 272 removed. The locking lever 272 fits between the two side walls 281, 282 (shown in FIG. 19) and the gear track slide lock 270 receives the channel 232 in space 285. When the locking lever 272 is pressed inward toward the gear track 278, the teeth 274 on a right-angled upper portion of locking lever 272 are removed from the gear track 278 of the channel 232 which allows the slide lock 270 to be moved up or down the gear track 278 to achieve the desired positioning of the ladder stabilizer 212 on the steps 15, 18 of the step ladder 10.

The locking lever 272 rotates about a spring pin 276 or a rivet and a leaf spring 275 and is positioned between the inside of the handle of the locking lever 272 and an inner surface of the gear track slide lock 270 opposite the handle. An end of the leaf spring 279 fits in a notch 271 on the inner surface of the handle of the locking lever 272 which holds the leaf spring 279 in place. The upper end of the locking lever 272 comprises the right angled portion having rectangular teeth 274 as shown in FIG. 17. The rectangular teeth 274 have a height of approximately one-eighth inch and the teeth 274 mesh with the rectangular teeth 277 of gear track 278 on the outer surface of the channel 232. The rectangular teeth 277 have a height of approximately one-eighth inch similar to the teeth 274 on the end of the locking lever 272. The leaf spring 275 keeps the right angled teeth 274 meshed with the teeth 277 of gear track 278 so that the gear track slide lock 270 is self-locking, and only unlocks when the lower end of locking lever 272 is moved inward toward the gear track 278. An opening 279 is provided in the gear track slide lock 270 of sufficient size to allow the right-angled end of the locking lever 272 to protrude through the inside wall of gear track slide lock 270 and allow the teeth 274 to mesh with teeth 277 on the gear track 278.

Still referring to FIG. 17, FIG. 18, and FIG. 19, attached to the lower end of the gear track slide lock 270 is the swivel leg connector 240 which swivels about a spring pin 249 or rivet that attaches between the side walls 281, 282 in the space 283 of the gear track slide lock 270. A first stabilizer leg 224 attaches via an eye bolt 210 to the swivel leg connector 240, and a second stabilizer leg 228 attaches via another eye bolt 212 to the swivel leg connector 240 adjacent to the eye bolt 210. Spring pins or rivets 218, 220 extend through each eye bolt 210, 212 between two side walls 214, 216 of the swivel leg connector 240. The swivel leg connector 240 comprises a semicircular upper portion 247 that fits within the opening of the gear track slide lock 270 and between two side walls 281, 282 of the gear track slide lock 270 just below the locking lever 272. The upper portion 247 comprises a hole for insertion of a spring pin or rivet 249 to secure the upper portion 247 and allow the upper portion 247 to rotate about the pin 249.

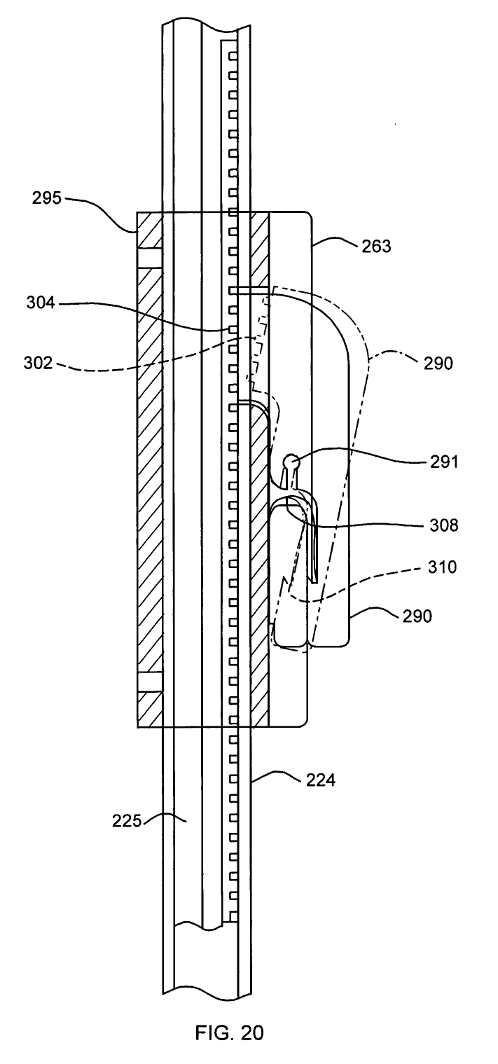

Referring to FIG. 16 and FIG. 20 and FIG. 21, FIG. 20 is a side elevational cross-section view of a leg lock assembly 263 positioned on a leg 224 of the alternate embodiment of the step ladder stabilizer 212. The leg lock assembly 263 comprises a rectangular block 295 with an opening through the center of the block 295 for receiving a leg 224 of the ladder stabilizer 212.

FIG. 21 is an end view of the leg lock assembly 263 showing the side walls 293, 294 for receiving a lock lever 290 and an extension leg 225 which is retractable within the leg 224. The leg lock assembly 263 is mechanically pressed into position on the leg 224 as shown in FIG. 16. The lock lever 290 is secured between the side walls 293, 294 by a spring pin or rivet 291 around which the lock lever 290 rotates. A right-angled upper portion of the lock lever 290 comprises teeth 302 which mesh with gear track teeth 304 on a side of the retractable extension leg 225. The teeth 302 on the right-angled upper portion of lock lever 290 have a height of approximately one-eighth inch and the teeth 304 of the extension legs 225 have a height of approximately one-eighth inch for meshing with teeth 302. An opening 306 is provided in a side of the leg 224 to enable the teeth 302 on the right-angled upper portion of the lock lever 290 to pass through the leg 224 and mesh with the teeth 304 on the retractable extension leg 225. The lock lever 290 is held in position between the side walls 293, 294 by a spring pin or rivet 291 around which the lock lever 290 rotates. An end of a leaf spring 308 fits in a notch 290 on the underside of the lock lever 290 and the other end of the leaf spring 308 rests against a surface of the slide lock assembly 263. The leaf spring 308 keeps the right-angled teeth 302 meshed with the teeth 304 of the retractable extension leg 225 so that the lock lever 290 is self-locking, and only unlocks when the lower end of locking lever 290 is moved inward toward the extension leg 225. The slide lock assembly 265 mounted on leg 228 is constructed the same as slide lock assembly 263 which mounts on leg 224.

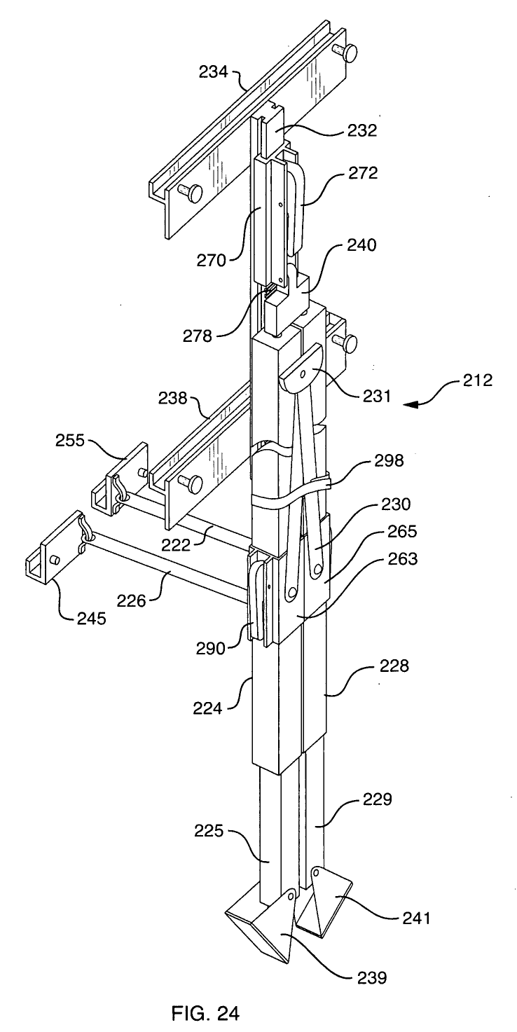

Referring to FIG. 24, a perspective view of the step ladder stabilizer 212 shown in FIGS. 15 and 16 is removed from the step ladder 10 and shown in a closed position in FIG. 24. In order to achieve the closed position, the release bracket 231 of the spreader bar 230 is moved upward, and the arms 230 of the spreader bar 230 fold up almost parallel to each other which causes the stabilizer legs 224, 228 to move toward each other. Next the lock lever 272 of the gear track slide lock 270 is pushed inward to unlock the gear track slide lock 270 and then the gear track slide lock 270 is moved toward the top of the channel 232 causing the two stabilizer legs 224, 228 to close and be parallel to the channel 232. The extension legs 225, 229 may be retracted into the stabilizer legs 224, 228 by compressing the levers 290, 292 on the leg lock assemblies 263, 265. The arms 225 and 226 which are shown extended in FIG. 25 are moved to rest along the sides of the stabilizer legs 224, 228. A Velcro strap 298 attached to the lower end of the channel 232 may be used to secure the arms, legs, channel and spreader bar closely together when the ladder stabilizer 212 is in the closed position.

The preferred embodiment of the alternate step ladder stabilizer 212 shown in FIGS. 15, 16 and 25 comprises elements with the following dimensions, but one or ordinary skill in the art will recognize that there are many variations to such dimensions that will work equally well. The stabilizer legs 224, 228, which may be made of fiberglass to reduce weight or aluminum, are approximately 48 inches long and 1 inch square. The channel is approximately 30 inches long. The upper step clamp 234 is approximately 6 inches wide and 3.25 inches high. The slide lock 270 is approximately 6 inches long, and the leg lock assemblies are approximately 5.5 inches long. Each of the two segments of the spreader bar 230, is approximately 20 inches long. The arms 222, 226 are approximately 20.5 inches long. The retractable extension leg is approximately 35 inches long, except for the legs 224, 226 and the spreader bar 230 the other components are made from common aluminum stock.

This invention has been disclosed in terms of certain embodiments. It will be apparent that many modifications can be made to the disclosed apparatus without departing from the invention. Therefore, it is the intent of the appended claims to cover all such variations and modifications as come within the true spirit and scope of this invention.

What is claimed is:

1. A stabilizer for a step ladder comprising:
means for attaching an upper portion of said stabilizer to said step ladder;
means attached to said upper portion of said stabilizer for mounting a pair of legs; and
means attached to said legs for securing said legs to a lower portion of said ladder, the distance between said legs being controlled by a spreader bar.

2. The stabilizer as recited in claim 1 wherein said attaching means of an upper portion of said stabilizer to said step ladder comprises a channel, said channel comprises an upper bracket and a lower bracket for attaching said channel to steps of said step ladder.

3. The stabilizer as recited in claim 1 wherein:
said leg mounting means comprises a slide lock attached to said channel; and
means extending from a portion of said slide lock for attaching said legs to said slide lock.

4. The stabilizer as recited in claim 1 wherein said legs securing means to a lower portion of said ladder comprises arms extending from each of said legs, said arms being connected to clamps for attaching to a step of said ladder.

5. The stabilizer as recited in claim 1 wherein each of said legs comprises an adjustable extension leg within each of said legs.

6. The stabilizer as recited in claim 5 wherein said adjustable extension leg within each of said legs is controlled by a lock lever mechanism positioned on each of said legs.

7. A stabilizer for a step ladder comprising:
a channel, said channel comprises a gear track along one side;
means positioned on an upper portion and a lower portion of said channel for attaching said channel to a front step portion of said step ladder;
means attached to said channel for mounting a pair of legs wherein said legs extend or retract in accordance with the movement of said mounting means along said channel;
means attached between said pair of legs for fixing said legs in a spaced-apart position and for releasing said legs to
means for securing each leg of said pair of legs to said front step portion of said step ladder.

8. The stabilizer as recited in claim 7 wherein said mounting means comprises a slide lock adapted to move along said
channel and having a lock lever to control said slide lock.

9. The stabilizer as recited in claim 7 wherein said pair of legs securing means comprises a first arm attached between a first one of said pair of legs and said front step portion of said step ladder, and a second arm attached between a second one of said pair of legs and said front step portion of said step ladder.

10. A stabilizer for a step ladder comprising:
a channel having an upper bracket and a lower bracket for mounting said channel to a front step portion of said step ladder;
a slide lock adapted to slide along said channel and be locked at a preferred position;
a leg connector rotatably attached at an end of said slide
a first leg of said stabilizer attached to a first side of said leg connector, said first leg extending downward away from said channel;
a second leg of said stabilizer attached to a second side of said leg connector, said second leg extending downward away from said channel;
a spreader bar attached between said first leg and said second leg;
a first arm of said stabilizer having a first end attached to a first-leg lock assembly positioned on said first leg and a second end adapted to attach to said front step portion of said step ladder; and
a second arm having a first end attached to a second leg lock assembly positioned on said second leg and a second end adapted to attach to said front step portion of said step ladder.

11. The step ladder stabilizer as recited in claim 10 wherein said spreader bar comprises means for folding-up said spreader bar.

12. The step ladder stabilizer as recited in claim 10 wherein said slide lock comprises means for securing said slide lock along a gear track on said channel at said preferred position to stabilize said step ladder.

13. The step ladder stabilizer as recited in claim 12 wherein said slide lock securing means comprises a control lever having teeth for meshing with said gear track on said channel.

14. The step ladder stabilizer as recited in claim 10 wherein each of said first leg and said second leg comprises an extension leg which extends from said first leg and said second leg to stabilize said step ladder.

15. The step ladder stabilizer as recited in claim 14 wherein each of said first leg lock assembly on said first leg and said second leg lock assembly on said second leg comprises a lock lever for securing each extension leg in a preferred position to stabilize said step ladder.

16. The step ladder stabilizer as recited in claim 15 wherein said extension leg comprises a gear track wherein a portion of said lock lever comprises teeth which mesh with said gear track for securing said extension leg in said preferred position.

17. The step ladder stabilizer as recited in claim 10 wherein said stabilizer closes against said channel when said slide lock is moved to a top portion of said channel.

18. The stabilizer as recited in claim 10 wherein said slide lock comprises:
a lever having means on an end of a right angled portion of said lever for griping a gear track surface of said channel when said lever is in a nonactivated locked position;
a frame for mounting said slide lock to grooved surfaces of said channel, said frame having an opening for said end of said right angled portion of said lever to enter for gripping said gear track surface of said channel;
means for securing said right angled lever within a pair of walls running on the outside and length of said frame to enable said lever to rotate about said securing means wherein said right angled portion of said lever protrudes through said opening in said frame when said lever is in said nonactivated locked position; and
a U-shaped spring, one end attached to said frame below a handle portion of said lever and the other end positioned against an underside of said handle portion of said lever wherein said U-shaped spring maintains said lever in said nonactivated locked position.

19. The slide lock as recited in claim 18 wherein said griping means comprises a plurality of teeth on said end of a right angled portion of said lever for meshing with said gear track of a channel.

20. The slide lock as recited in claim 18 wherein said U-shaped spring comprises a U-shaped leaf spring.

21. In combination:
a step ladder having a front step section and a rear prop section, said rear prop section being movably attached to a top portion of said step ladder adjacent to said front step section;
a step ladder stabilizer, attached to said front step section and extending between said front step section and said rear prop section to provide stabilization, comprising:
a channel having an upper bracket and a lower bracket for mounting to said front step section of said step ladder;
a slide lock adapted to slide along said channel and be locked at a preferred position;
a first leg attached to a rotatable portion of said slide lock, said first leg extending downward away from said channel;
a second leg attached to said rotatable portion of said slide lock, said second leg extending downward away from said channel;
a spreader bar attached between said first leg and said second leg;
a first arm having a first end attached to said first leg and a second end adapted to attach to said front section of said step ladder; and
a second arm having a first end attached to said second leg and a second end adapted to attach to said front step section of said step ladder.

22. The combination as recited in claim 21 wherein said spreader bar comprises means for folding-up said spreader bar.

23. The combination as recited in claim 21 wherein said slide lock comprises means for securing said slide lock along said channel at said preferred position to stabilize said step ladder.

24. The combination as recited in claim 21 wherein each of said first leg and said second leg comprises an extension leg which extends from said first leg and said second leg to stabilize said step ladder.

25. The combination as recited in claim 24 wherein each of said first leg and said second leg comprises a leg lock assembly, said leg lock assembly comprises a lock lever for securing said extension leg in a preferred position to stabilize said step ladder.

26. The combination as recited in claim 21 wherein said step ladder stabilizer closes against said front step portion of said step ladder when said slide lock is raised along said channel.

27. A stabilizer for a step ladder comprising:
a channel having an upper bracket and a lower bracket for mounting said channel to a front step portion of said step ladder;
a slide lock bracket adapted to slide along slots in opposite sides of said channel and to be locked at a preferred position;
a first leg of said stabilizer attached to a first side of said sliding lock bracket, said first leg extending downward away from said channel;
a second leg of said stabilizer attached to a second side of said sliding lock bracket, said second leg extending downward away from said channel;
a spreader bar attached between said first leg and said second leg;
a first arm of said stabilizer having a first end attached to said first leg and a second end adapted to attach to said front step portion of said step ladder; and
a second arm having a first end attached to said second leg and a second end adapted to attach to said front step portion of said step ladder.

28. The step ladder stabilizer as recited in claim 27 wherein said spreader bar comprises means for folding-up said spreader bar.

29. The step ladder stabilizer as recited in claim 27 wherein said slide lock bracket comprises means for securing said slide lock bracket along said channel at said preferred position to stabilize said step ladder.

30. The step ladder stabilizer as recited in claim 27 wherein each of said first leg and said second leg comprises an extension leg which extends from said first leg and said second leg to stabilize said step ladder.

31. The step ladder as recited in claim 27 wherein said stabilizer closes against said channel when said slide lock bracket is raised along said channel.

32. A slide lock assembly comprising:
a lever having means on an end of a right angled portion of said lever for griping a gear track surface of a channel when said lever is in a nonactivated locked position;
a frame for mounting said slide lock assembly to grooved surfaces of said channel, said frame having an opening for said end of said right angled portion of said lever to enter;
means for securing said right angled lever within a pair of walls running on the outside and length of said frame to enable said lever to rotate about said securing means wherein said right angled portion of said lever protrudes through said opening in said frame when said lever is in said nonactivated, locked position; and
a U-shaped spring, one end attached to said frame below a handle portion of said lever and the other end positioned against an underside of said handle portion of said lever wherein said U-shaped spring maintains said lever in said nonactivated locked position.

33. The slide lock assembly as recited in claim 32 wherein said griping means comprises a plurality of teeth on said end of a right angled portion of said lever for meshing with said gear track of a channel.

34. The slide lock assembly as recited in claim 32 wherein said U-shaped spring comprises a U-shaped leaf spring.

35. The slide lock assembly as recited in claim 32 comprises a leg connector rotatably attached to a lower end of said slide lock assembly.

36. A method of stabilizing a step ladder comprising the steps of:
providing a channel, said channel comprises a gear track along one side;
attaching said channel to a front step portion of said step ladder with means positioned on an upper portion and a lower portion of said channel;
mounting a pair of legs to said channel with means to enable said legs to extend or retract in accordance with the movement of said mounting means along said channel;
attaching means between said pair of legs for fixing said legs in a spaced-apart position and for releasing said legs to enable said pair of legs to be moved adjacent to said channel; and
securing each leg of said pair of legs to said front step portion of said step ladder with connector means.

37. The method as recited in claim 36 wherein said step of mounting said pair of legs to said channel with enabling means to allow said legs to extend away from a front portion of said step ladder or to retract said legs comprises the step of providing a slide lock adapted to move along said channel, said slide lock includes a lock lever to control said slide lock.

38. The method as recited in claim 36 wherein said step of securing said pair of legs comprises the steps of attaching a first arm between a first one of said pair of legs and said front step portion of said step ladder, and attaching a second arm between a second one of said pair of legs and said front step portion of said step ladder.

39. A method of providing a stabilizer for a step ladder comprising the steps of:
providing a channel having an upper bracket and a lower bracket for mounting said channel to a front step portion of said step ladder;
adapting a slide lock to slide along said channel and to be locked at a preferred position;
attaching a leg connector at an end of said slide lock, said leg connector being rotatable about said end.
attaching a first leg of said stabilizer to a first side of said leg connector, said first leg extending downward away from said channel;
attaching a second leg of said stabilizer to a second side of said leg connector, said second leg extending downward away from said channel;
attaching a spreader bar between said first leg and said second leg;
providing a first arm of said stabilizer having a first end attached to said first leg and a second end adapted to attach to said front step portion of said step ladder; and
providing a second arm having a first end attached to said second leg and a second end adapted to attach to said front step portion of said step ladder.

40. The method as recited in claim 39 wherein said step of attaching a spreader bar comprises the step of providing means for folding-up said spreader bar.

41. The method as recited in claim 36 wherein said step of adapting said slide lock to slide along said channel comprises the step of providing means for securing said slide lock along a gear track on said channel at said preferred position to stabilize said step ladder.

42. The method as recited in claim 41 wherein said step Of providing means for securing said slide lock along a gear track on said channel comprises the step of providing a control lever having teeth for meshing with said gear track on said channel.

43. The method as recited in claim 39 wherein said method comprises the step of providing each of said first leg and said second leg with an extension leg which extends from within said first leg and said second leg to stabilize said step ladder.

44. The method as recited in claim 39 wherein said method comprises the step of closing said stabilizer against said channel when said slide lock is raised along said channel.

45. The method as recited in claim 43 wherein said steps of providing each of said first leg and said second leg with an extension leg comprises the steps of attaching a first leg lock assembly along said first leg and attaching a second leg lock assembly along said second leg for locking each extension leg in a preferred position to stabilize said step ladder.

46. The method as recited in claim 45 wherein said step of providing each of said first leg and said second leg with an extension leg comprises the steps of:
providing a gear track on a portion of a surface of each extension leg; and
providing a leg lock assembly on each of said first leg and said second leg, wherein said leg lock assembly comprises a lock lever for meshing with said gear track on said extension leg to secure said first leg and said second leg in a preferred position to stabilize said step ladder.
